(19) United States
(12) Patent Application Publication
(10) Pub. No.: US 2024/0257396 A1
(43) Pub. Date: Aug. 1, 2024

(54) LEARNING DEVICE, LEARNING METHOD, NON-TRANSITORY COMPUTER READABLE RECORDING MEDIUM STORING LEARNING PROGRAM, CAMERA PARAMETER CALCULATING DEVICE, CAMERA PARAMETER CALCULATING METHOD, AND NON-TRANSITORY COMPUTER READABLE RECORDING MEDIUM STORING CAMERA PARAMETER CALCULATING PROGRAM

(71) Applicant: Panasonic Intellectual Property Corporation of America, Torrance, CA (US)

(72) Inventor: Nobuhiko WAKAI, Tokyo (JP)

(73) Assignee: Panasonic Intellectual Property Corporation of America, Torrance, CA (US)

(21) Appl. No.: 18/633,157

(22) Filed: Apr. 11, 2024

Related U.S. Application Data
(63) Continuation of application No. PCT/JP2022/033939, filed on Sep. 9, 2022.
(60) Provisional application No. 63/254,735, filed on Oct. 12, 2021.

(51) Int. Cl. G06T 7/80

(52) U.S. Cl. CPC G06T 7/80; G06T 2207/20081; G06T 2207/20084; G06T 2207/30244

(57) ABSTRACT

A learning part of a learning device performs a deep learning of deep neural networks using an acquired image and acquired coordinates of a plurality of true vanishing points, estimates coordinates of a plurality of vanishing points to calculate a tilt angle, a pan angle, and a roll angle of a camera by inputting the image to the deep neural networks, calculates a network error indicative of an error in the tilt angle, the pan angle, and the roll angle on the basis of the coordinates of the plurality of true vanishing points and the estimated coordinates of the plurality of vanishing points, and learns a parameter of the deep neural networks so as to minimize the calculated network error.

### FIELD OF INVENTION

The present disclosure relates to a technique of learning deep neural networks for calculating a camera parameter from an image and a technique of calculating a camera parameter from an image.

### BACKGROUND ART

A geometry-based method for performing a camera calibration for a sensing camera or the like requires an association of three-dimensional coordinates in a three-dimensional space with a pixel position of a two-dimensional image. Conventionally, three-dimensional coordinates and a pixel position of a two-dimensional image are associated with each other by taking an image of a repeating pattern having a known shape and detecting an intersection or a center of a circle from the obtained image.

Further, as a method for performing a robust camera calibration against brightness of an image or a subject by use of an input image, there has been suggested a deep learning-based method. The camera calibration is to calculate a camera parameter.

For example, in Non-Patent Literature 1, a camera parameter is calculated by a geometry-based method of associating three-dimensional coordinates in a three-dimensional space with a pixel position of a two-dimensional image by use of a calibration index.

For example, Non-Patent Literature 2 discloses a deep learning-based method of performing a camera calibration from an image on the basis of Manhattan World Assumption.

The method of Non-Patent Literature 1 requires the process of taking an image of a repeating pattern having a known shape, the process of detecting an intersection or a center of a circle from the obtained image, and the process of associating three-dimensional coordinates with a pixel position of the two-dimensional image. Such camera calibration is complicated and may not be easily performable.

Further, the method of Non-Patent Literature 2, in which the posture of a camera is estimated on the basis of a vanishing point that is an intersection of a plurality of lines obtained by line detection, makes it difficult to perform camera calibration of a camera in which a horizontal line changes to an elliptical line, e.g., a fisheye camera.
Non-Patent Literature 1: R. Y. Tsai, “A versatile Camera Calibration Technique for High-Accuracy 3D Machine Vision Metrology Using Off-the-Shelf TV Cameras and Lenses”, IEEE Journal of Robotics and Automation, Volume 3, Number 4, pages 323-344, August 1987
Non-Patent Literature 2: J. Lee, M. Sung, H. Lee, and J. Kim, “Neural Geometric Parser for Single Image Camera Calibration”, European Conference on Computer Vision, Volume 12357, pages 541-557, 2020

### SUMMARY OF THE INVENTION

The present disclosure has been made to solve the above-mentioned problems, and an object thereof is to provide a technique of calculating a camera parameter from an image having a distortion with high accuracy.

A learning device according to the present disclosure includes: an image acquisition part for acquiring an image taken by a camera that causes a distortion; a vanishing point acquisition part for acquiring coordinates of a plurality of true vanishing points to calculate a tilt angle, a pan angle, and a roll angle of the camera; a learning part for performing a deep learning of deep neural networks using the image acquired by the image acquisition part and the coordinates of the plurality of true vanishing points acquired by the vanishing point acquisition part; and an output part for outputting the deep neural networks learned in the learning part, wherein the learning part estimates coordinates of a plurality of vanishing points to calculate the tilt angle, the pan angle, and the roll angle of the camera by inputting the image to the deep neural networks, calculates a network error indicative of an error in the tilt angle, the pan angle, and the roll angle on the basis of the coordinates of the plurality of true vanishing points and the estimated coordinates of the plurality of vanishing points, and learns a parameter of the deep neural networks so as to minimize the calculated network error.

According to the present disclosure, a camera parameter can be calculated from an image having a distortion with high accuracy.

### BRIEF DESCRIPTION OF THE DRAWINGS

FIG. 1 is a block diagram showing an exemplary structure of a camera parameter calculation system according to an embodiment of the present disclosure.

FIG. 2 is a flowchart showing an exemplary camera parameter calculation of a camera parameter calculation device according to the embodiment of the present disclosure.

FIG. 3 is a diagram for explaining a world coordinates system in Manhattan World Assumption.

FIG. 4 is an illustration showing an exemplary first fisheye image in the embodiment.

FIG. 5 is an illustration showing an exemplary second fisheye image in the embodiment.

FIG. 6 is an illustration showing an exemplary third fisheye image in the embodiment.

FIG. 7 is an illustration showing an exemplary fourth fisheye image in the embodiment.

FIG. 8 is a diagram for explaining a method of calculating a roll angle.

FIG. 9 is a diagram for explaining a method of calculating a tilt angle using the first fisheye image rotated according to the roll angle.

FIG. 10 is a diagram for explaining a method of calculating a tilt angle using the second fisheye image rotated according to the roll angle.

FIG. 11 is a diagram for explaining a method of calculating a pan angle.

FIG. 12 is a block diagram showing an exemplary structure of a learning device according to the embodiment of the present disclosure.

FIG. 13 is a flowchart showing an exemplary learning process of the learning device according to the embodiment of the present disclosure.

FIG. 14 is a flowchart showing an exemplary DNN learning process in Step 13 in FIG. 13.

FIG. 15 is a diagram for explaining a method of calculating a network error in the embodiment.

### DETAILED DESCRIPTION

### Underlying Findings for Present Disclosure

Recently, sensing has been executed by a camera. However, a camera calibration is required to execute a highly accurate image recognition. In camera calibration of a camera having a large lens distortion such as a fisheye camera, it is difficult to calculate a camera parameter from an image having a distortion with high accuracy by a conventional deep learning-based camera calibration.

To solve the above-mentioned problems, the following techniques will be disclosed.
(1) A learning device according to an aspect of the present disclosure includes: an image acquisition part for acquiring an image taken by a camera that causes a distortion; a vanishing point acquisition part for acquiring coordinates of a plurality of true vanishing points to calculate a tilt angle, a pan angle, and a roll angle of the camera; a learning part for performing a deep learning of deep neural networks using the image acquired by the image acquisition part and the coordinates of the plurality of true vanishing points acquired by the vanishing point acquisition part; and an output part for outputting the deep neural networks learned in the learning part, wherein the learning part estimates coordinates of a plurality of vanishing points to calculate the tilt angle, the pan angle, and the roll angle of the camera by inputting the image to the deep neural networks, calculates a network error indicative of an error in the tilt angle, the pan angle, and the roll angle on the basis of the coordinates of the plurality of true vanishing points and the estimated coordinates of the plurality of vanishing points, and learns a parameter of the deep neural networks so as to minimize the calculated network error.

In this configuration, coordinates of a plurality of vanishing points to calculate a tilt angle, a pan angle, and a roll angle of the camera are estimated by inputting an image having a distortion to deep neural networks learned by a deep learning. From the estimated coordinates of the plurality of vanishing points, the tilt angle, the pan angle and the roll angle of the camera, which are camera parameters, can be calculated. Thus, a camera parameter can be calculated from an image having a distortion with high accuracy.
(2) In the learning device described in (1) above, the plurality of vanishing points may include a first vanishing point along a frontward direction of the camera, a second vanishing point along a zenithal direction of the camera, a third vanishing point along a rightward direction of the camera, and a fourth vanishing point along a leftward direction of the camera over the image.

In this configuration, when each coordinate of the estimated first vanishing point, second vanishing point, third vanishing point, and fourth vanishing point and each coordinate of the true first vanishing point, second vanishing point, third vanishing point, and fourth vanishing point are obtained, a network error indicative of an error in the tilt angle, the pan angle, and the roll angle of the camera can be calculated with high accuracy.
(3) In the learning device described in (2) above, the learning part may calculate a first distance between a perpendicular bisector of a line segment connecting the true third vanishing point and the true fourth vanishing point and a line that is parallel to the perpendicular bisector and passes through the estimated first vanishing point, calculate a second distance between the perpendicular bisector and a line that is parallel to the perpendicular bisector and passes through the estimated second vanishing point, calculate a third distance between the true first vanishing point and the estimated first vanishing point in a direction along the perpendicular bisector, calculate a fourth distance between the true second vanishing point and the estimated second vanishing point in the direction along the perpendicular bisector, calculate an angle between the line segment connecting the true third vanishing point and the true fourth vanishing point and a line segment connecting the estimated third vanishing point and the estimated fourth vanishing point, and calculate a sum of the first distance, the second distance, the third distance, the fourth distance, and the angle as the network error.

In this configuration, the first distance between the perpendicular bisector of the line segment connecting the true third vanishing point and the true fourth vanishing point and the line that is parallel to the perpendicular bisector and passes through the estimated first vanishing point corresponds to an error in the pan angle. The second distance between the perpendicular bisector and the line that is parallel to the perpendicular bisector and passes through the estimated second vanishing point also corresponds to the error in the pan angle. Further, the third distance between the true first vanishing point and the estimated first vanishing point in the direction along the perpendicular bisector corresponds to an error in the tilt angle. The fourth distance between the true second vanishing point and the estimated second vanishing point in the direction along the perpendicular bisector also corresponds to the error in the tilt angle. Further, the angle between the line segment connecting the true third vanishing point and the true fourth vanishing point and a line segment connecting the estimated third vanishing point and the estimated fourth vanishing point corresponds to an error in the roll angle.

Accordingly, the sum of the first distance, the second distance, the third distance, the fourth distance, and the angle is calculated as the network error and the parameter of the deep neural networks is learned so as to minimize the network error. The tilt angle, the pan angle and the roll angle of the camera, which are camera parameters, can be thereby calculated with high accuracy.

The present disclosure can be realized not only as a learning device including the distinctive configurations as described above, but also as a learning method in which distinctive processes corresponding to the distinctive configurations of the learning device are executed. The present disclosure also can be realized as a computer program causing a computer to execute the distinctive processes included in the learning method. Accordingly, other aspects described below also can exert similar advantageous effects to the learning device described above.
(4) A learning method according to another aspect of the present disclosure, by a computer, includes: acquiring an image taken by a camera that causes a distortion; acquiring coordinates of a plurality of true vanishing points to calculate a tilt angle, a pan angle, and a roll angle of the camera; performing a deep learning of deep neural networks using the acquired image and the acquired coordinates of the plurality of true vanishing points; and outputting the learned deep neural networks, wherein in the learning of the deep neural networks, coordinates of a plurality of vanishing points to calculate the tilt angle, the pan angle, and the roll angle of the camera are estimated by inputting the image to the deep neural networks, a network error indicative of an error in the tilt angle, the pan angle, and the roll angle is calculated on the basis of the coordinates of the plurality of true vanishing points and the estimated coordinates of the plurality of vanishing points, and a parameter of the deep neural networks is learned so as to minimize the calculated network error.
(5) A learning program according to another aspect of the present disclosure causes a computer to serve as: an image acquisition part for acquiring an image taken by a camera that causes a distortion; a vanishing point acquisition part for acquiring coordinates of a plurality of true vanishing points to calculate a tilt angle, a pan angle, and a roll angle of the camera; a learning part for performing a deep learning of deep neural networks using the image acquired by the image acquisition part and the coordinates of the plurality of true vanishing points acquired by the vanishing point acquisition part; and an output part for outputting the deep neural networks learned in the learning part, wherein the learning part estimates coordinates of a plurality of vanishing points to calculate the tilt angle, the pan angle, and the roll angle of the camera by inputting the image to the deep neural networks, calculates a network error indicative of an error in the tilt angle, the pan angle, and the roll angle on the basis of the coordinates of the plurality of true vanishing points and the estimated coordinates of the plurality of vanishing points, and learns a parameter of the deep neural networks so as to minimize the calculated network error.
(6) A camera parameter calculation device according to another aspect of the present disclosure includes: an image acquisition part for acquiring an image taken by a camera that causes a distortion; an estimation part for estimating coordinates of a plurality of vanishing points to calculate a tilt angle, a pan angle, and a roll angle of the camera by inputting the image acquired by the image acquisition part to deep neural networks learned by a deep learning; a calculation part for calculating the tilt angle, the pan angle, and the roll angle on the basis of the coordinates of the plurality of vanishing points estimated by the estimation part; and an output part for outputting a camera parameter including the tilt angle, the pan angle, and the roll angle calculated by the calculation part, wherein in the learning of the deep neural networks, a learning-use image is acquired, coordinates of a plurality of true vanishing points to calculate a tilt angle, a pan angle, and a roll angle of a camera used for taking the learning-use image are acquired, coordinates of a plurality of vanishing points to calculate the tilt angle, the pan angle, and the roll angle of the camera used for taking the learning-use image are estimated by inputting the learning-use image to the deep neural networks, a network error indicative of an error in the tilt angle, the pan angle, and the roll angle is calculated on the basis of the coordinates of the plurality of true vanishing points and the estimated coordinates of the plurality of vanishing points, and a parameter of the deep neural networks is learned so as to minimize the calculated network error.

In this configuration, coordinates of a plurality of vanishing points to calculate a tilt angle, a pan angle, and a roll angle of the camera are estimated by inputting an image having a distortion to deep neural networks learned by a deep learning. From the estimated coordinates of the plurality of vanishing points, the tilt angle, the pan angle and the roll angle, which are camera parameters, can be calculated. Thus, a camera parameter can be calculated from an image having a distortion with high accuracy.
(7) In the camera parameter calculation device described in (6) above, the plurality of vanishing points may include a first vanishing point along a frontward direction of the camera, a third vanishing point along a rightward direction of the camera, and a fourth vanishing point along a leftward direction of the camera over the image.

In this configuration, when each coordinate of the estimated first vanishing point, third vanishing point, and fourth vanishing point is obtained, the tilt angle, the pan angle, and the roll angle of the camera can be calculated with high accuracy.
(8) In the camera parameter calculation device described in (7) above, the calculation part may calculate the roll angle using a coordinate of the first vanishing point and a coordinate of a midpoint of a line segment connecting the third vanishing point and the fourth vanishing point, calculate the tilt angle using a y-coordinate of the first vanishing point, a y-coordinate of the midpoint of the line segment connecting the third vanishing point and the fourth vanishing point, and an inverse function of a projection function of the camera, and calculate the pan angle using an x-coordinate of a principal point of the camera in an image coordinate system, an x-coordinate of the midpoint of the line segment connecting the third vanishing point and the fourth vanishing point, and the inverse function of the projection function.

In this configuration, the roll angle is calculated by using the coordinate of the first vanishing point and the coordinate of the midpoint of the line segment connecting the third vanishing point and the fourth vanishing point; the tilt angle is calculated by using the y-coordinate of the first vanishing point, the y-coordinate of the midpoint of the line segment connecting the third vanishing point and the fourth vanishing point, and the inverse function of the projection function of the camera; and the pan angle is calculated by using the x-coordinate of the principal point of the camera in the image coordinate system, the x-coordinate of the midpoint of the line segment connecting the third vanishing point and the fourth vanishing point, and the inverse function of the projection function. Thus, the tilt angle, the pan angle, and the roll angle of the camera can be calculated by estimating each coordinate of the first vanishing point, the third vanishing point, and the fourth vanishing point.

The present disclosure can be realized not only as a camera parameter calculation device including distinctive configurations as described above, but also as a camera parameter calculation method in which distinctive processes corresponding to the distinctive configurations of the camera parameter calculation device are executed. The present disclosure also can be realized as a computer program causing a computer to execute the distinctive processes included in the camera parameter calculation method. Accordingly, other aspects described below also can exert similar advantageous effects to the camera parameter calculation device described above.
(9) A camera parameter calculation method according to another aspect of the present disclosure, by a computer, includes: acquiring an image taken by a camera that causes a distortion; estimating coordinates of a plurality of vanishing points to calculate a tilt angle, a pan angle, and a roll angle of the camera by inputting the acquired image to deep neural networks learned by a deep learning; calculating the tilt angle, the pan angle, and the roll angle on the basis of the estimated coordinates of the plurality of vanishing points; and outputting a camera parameter including the calculated tilt angle, pan angle, and roll angle, wherein in the learning of the deep neural networks, a learning-use image is acquired, coordinates of a plurality of true vanishing points to calculate a tilt angle, a pan angle, and a roll angle of a camera used for taking the learning-use image are acquired, coordinates of a plurality of vanishing points to calculate the tilt angle, the pan angle, and the roll angle of the camera used for taking the learning-use image are estimated by inputting the learning-use image to the deep neural networks, a network error indicative of an error in the tilt angle, the pan angle, and the roll angle is calculated on the basis of the coordinates of the plurality of true vanishing points and the estimated coordinates of the plurality of vanishing points, and a parameter of the deep neural networks is learned so as to minimize the calculated network error.
(10) A camera parameter calculation program according to another aspect of the present disclosure causes a computer to serve as: an image acquisition part for acquiring an image taken by a camera that causes a distortion; an estimation part for estimating coordinates of a plurality of vanishing points to calculate a tilt angle, a pan angle, and a roll angle of the camera by inputting the image acquired by the image acquisition part to deep neural networks learned by a deep learning; a calculation part for calculating the tilt angle, the pan angle, and the roll angle on the basis of the coordinates of the plurality of vanishing points estimated by the estimation part; and an output part for outputting a camera parameter including the tilt angle, the pan angle, and the roll angle calculated by the calculation part, wherein in the learning of the deep neural networks, a learning-use image is acquired, coordinates of a plurality of true vanishing points to calculate a tilt angle, a pan angle, and a roll angle of a camera used for taking the learning-use image are acquired, coordinates of a plurality of vanishing points to calculate the tilt angle, the pan angle, and the roll angle of the camera used for taking the learning-use image are estimated by inputting the learning-use image to the deep neural networks, a network error indicative of an error in the tilt angle, the pan angle, and the roll angle is calculated on the basis of the coordinates of the plurality of true vanishing points and the estimated coordinates of the plurality of vanishing points, and a parameter of the deep neural networks is learned so as to minimize the calculated network error.

Additionally, the present disclosure allows distribution of the program as a non-transitory computer readable storage medium like a CD-ROM, or via a communication network like the Internet. Accordingly, other aspects described below also can exert similar advantageous effects to the learning device or the camera parameter calculation device described above.
(11) A non-transitory computer readable recording medium storing a learning program according to another aspect of the present disclosure causes a computer to serve as: an image acquisition part for acquiring an image taken by a camera that causes a distortion; a vanishing point acquisition part for acquiring coordinates of a plurality of true vanishing points to calculate a tilt angle, a pan angle, and a roll angle of the camera; a learning part for performing a deep learning of deep neural networks using the image acquired by the image acquisition part and the coordinates of the plurality of true vanishing points acquired by the vanishing point acquisition part; and an output part for outputting the deep neural networks learned in the learning part, wherein the learning part estimates coordinates of a plurality of vanishing points to calculate the tilt angle, the pan angle, and the roll angle of the camera by inputting the image to the deep neural networks, calculates a network error indicative of an error in the tilt angle, the pan angle, and the roll angle on the basis of the coordinates of the plurality of true vanishing points and the estimated coordinates of the plurality of vanishing points, and learns a parameter of the deep neural networks so as to minimize the calculated network error.
(12) A non-transitory computer readable recording medium storing a camera parameter calculation program according to another aspect of the present disclosure causes a computer to serve as: an image acquisition part for acquiring an image taken by a camera that causes a distortion; an estimation part for estimating coordinates of a plurality of vanishing points to calculate a tilt angle, a pan angle, and a roll angle of the camera by inputting the image acquired by the image acquisition part to deep neural networks learned by a deep learning; a calculation part for calculating the tilt angle, the pan angle, and the roll angle on the basis of the coordinates of the plurality of vanishing points estimated by the estimation part; and an output part for outputting a camera parameter including the tilt angle, the pan angle, and the roll angle calculated by the calculation part, wherein in the learning of the deep neural networks, a learning-use image is acquired, coordinates of a plurality of true vanishing points to calculate a tilt angle, a pan angle, and a roll angle of a camera used for taking the learning-use image are acquired, coordinates of a plurality of vanishing points to calculate the tilt angle, the pan angle, and the roll angle of the camera used for taking the learning-use image are estimated by inputting the learning-use image to the deep neural networks, a network error indicative of an error in the tilt angle, the pan angle, and the roll angle is calculated on the basis of the coordinates of the plurality of true vanishing points and the estimated coordinates of the plurality of vanishing points, and a parameter of the deep neural networks is learned so as to minimize the calculated network error.

Embodiments of the present disclosure will be described below with reference to the attached drawings. Each of the embodiments which will be described below represents a specific example of the disclosure. Numerical values, shapes, constituents, steps, and the order thereof described below are mere examples, and thus should not be construed to delimit the disclosure. Further, constituents which are not recited in the independent claims each showing the broadest concept among the constituents in the embodiments are described as selectable constituent. The respective contents are combinable with each other in all the embodiments.

### Embodiments

Embodiments of the present disclosure will be described below with reference to the drawings.

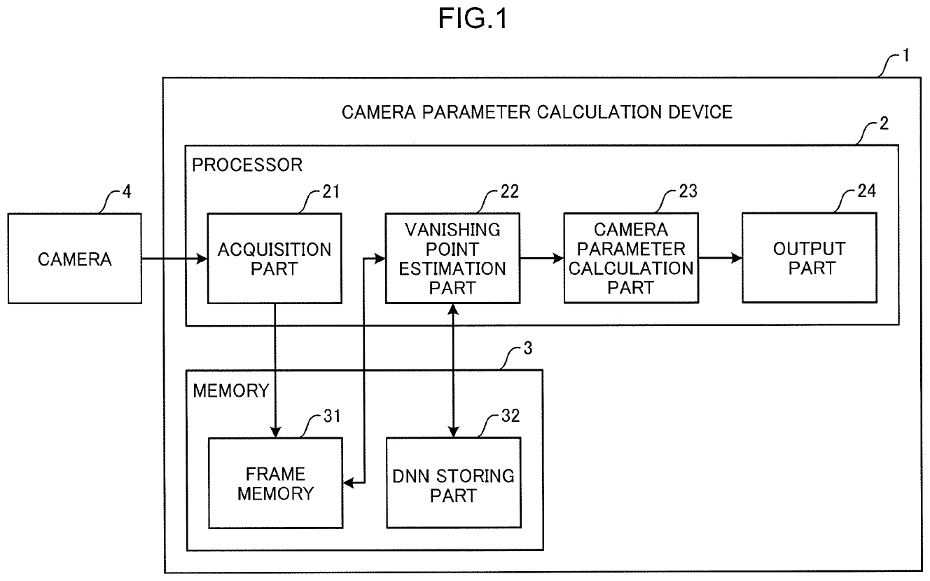

FIG. 1 is a block diagram showing an exemplary structure of a camera parameter calculation system according to an embodiment of the present disclosure.

The camera parameter calculation system includes a camera parameter calculation device 1 and a camera 4.

In the embodiment, the camera 4 is, for example, a fixed camera provided on a vehicle. The camera 4 takes an image of surroundings of the vehicle at a predetermined frame rate, and inputs the taken image to the camera parameter calculation device 1 at the predetermined frame rate. The camera 4 is, for example, a fisheye camera (ultra wide-angle camera) of which view angle is 180 degrees or more. The camera 4 may be a wide-angle camera of which view angle is not less than 60 degrees.

The camera parameter calculation device 1 is included in a computer having a processor 2, a memory 3, and an unillustrated interface circuit. The processor 2 includes, for example, a central processing unit. The memory 3 includes a storage device that is non-volatile and rewritable, e.g., a flash memory, a hard disk drive, or a solid state drive. The interface circuit includes, for example, a communication circuit.

The camera parameter calculation device 1 may be included in an edge server installed in the vehicle, or in a cloud server. In the case that the camera parameter calculation device 1 is included in the edge server, the camera 4 and the camera parameter calculation device 1 are connected with each other through a local area network. In the case that the camera parameter calculation device 1 is included in the cloud server, the camera 4 and the camera parameter calculation device 1 are connected with each other through a wide area network such as the Internet. A part of the configuration of the camera parameter calculation device 1 may be provided in the edge side device and the rest thereof may be provided in the cloud side device.

The processor 2 includes an acquisition part 21, a vanishing point estimation part 22, a camera parameter calculation part 23, and an output part 24. The acquisition part 21, the vanishing point estimation part 22, the camera parameter calculation part 23, and the output part 24 may do performance when the central processing unit executes a camera parameter calculation program, or may be constituted by dedicated hardware, e.g., an Application Specific Integrated Circuit (ASIC).

The acquisition part 21 acquires an image taken by the camera 4 that causes a distortion. The acquisition part 21 stores the acquired image in the frame memory 31.

The vanishing point estimation part 22 estimates coordinates of a plurality of vanishing points to calculate a tilt angle, a pan angle, and a roll angle of the camera 4 by inputting the image acquired by the acquisition part 21 to deep neural networks (hereinafter, also referred to as DNN) learned by deep learning. The vanishing point estimation part 22 reads out DNN from a DNN storing part 32. The vanishing point estimation part 22 estimates the coordinates of the vanishing points on the image by DNN learned by deep learning from the image read out from the frame memory 31. An example of DNN is convolutional neural networks including a convolutional layer and a pooling layer.

In the learning of DNN, a learning-use image is acquired. Next, coordinates of a plurality of true vanishing points to calculate a tilt angle, a pan angle, and a roll angle of a camera used for taking the learning-use image are acquired. Next, coordinates of a plurality of vanishing points to calculate the tilt angle, the pan angle, and the roll angle of the camera used for taking the learning-use image are estimated by inputting the learning-use image to DNN. Next, a network error indicative of an error in the tilt angle, the pan angle, and the roll angle is calculated on the basis of the coordinates of the plurality of true vanishing points and the estimated coordinates of the plurality of vanishing points. Next, a parameter of DNN is learned so as to minimize the calculated network error.

The true vanishing point is an exact vanishing point.

The plurality of vanishing points includes a first vanishing point along a frontward direction of the camera 4, a third vanishing point along a rightward direction of the camera 4, and a fourth vanishing point along a leftward direction of the camera 4 over the image.

The camera parameter calculation part 23 calculates the tilt angle, the pan angle, and the roll angle on the basis of the coordinates of the plurality of vanishing points estimated by the vanishing point estimation part 22. The tilt angle, the pan angle and the roll angle represent the posture of the camera 4, and are camera parameters.

The camera parameter calculation part 23 calculates the roll angle using the first vanishing point and a midpoint of a line segment connecting the third vanishing point and the fourth vanishing point. The camera parameter calculation part 23 calculates the tilt angle using a y-coordinate of the first vanishing point, a y-coordinate of the midpoint of the line segment connecting the third vanishing point and the fourth vanishing point, and an inverse function of a projection function of the camera 4. The camera parameter calculation part 23 calculates the pan angle using an x-coordinate of a principal point of the camera 4 in an image coordinate system, an x-coordinate of the midpoint of the line segment connecting the third vanishing point and the fourth vanishing point, and the inverse function of the projection function.

The output part 24 outputs the camera parameter including the tilt angle, the pan angle, and the roll angle calculated by the camera parameter calculation part 23.

The memory 3 includes the frame memory 31 and the DNN storing part 32.

The frame memory 31 stores the image that the acquisition part 21 acquires from the camera 4. The frame memory 31 stores the image acquired by the acquisition part 21 in a time series.

The DNN storing part 32 stores DNN to be used by the vanishing point estimation part 22 beforehand. The DNN storing part 32 stores DNN generated by a learning device 5 described later. DNN may be stored in the DNN storing part 32 at the time of manufacturing of the camera parameter calculation device 1, or may be received from an external server and stored in the DNN storing part 32.

The camera parameter calculation device 1 is not necessarily constituted by a single computer device, and may be constituted by an unillustrated distributed processing system including a terminal device and a server. For example, the terminal device may be provided with the acquisition part 21 and the frame memory 31, and the server may be provided with the DNN storing part 32, the vanishing point estimation part 22, the camera parameter calculation part 23, and the output part 24. In this case, reception and transmission of data between the components are executed through a communication line connected to the terminal device and the server.

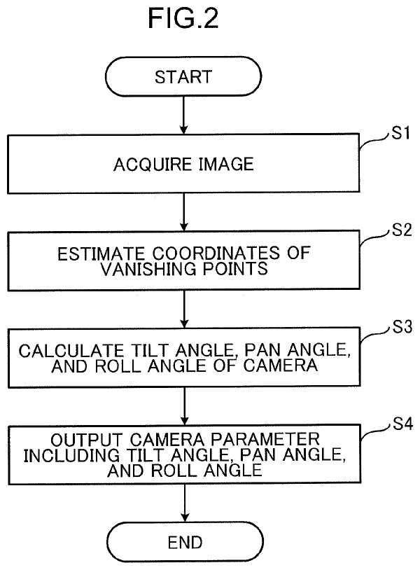

FIG. 2 is a flowchart showing an exemplary camera parameter calculation of the camera parameter calculation device 1 according to the embodiment of the present disclosure. The operation of the camera parameter calculation device 1 will be described below with reference to FIG. 2. The camera parameter calculation is executed when the camera 4 is installed, and executed thereafter periodically, e.g., every week or every month.

First, in Step S1, the acquisition part 21 acquires an image (fisheye image) taken by the camera 4. The acquisition part 21 stores the acquired image in the frame memory 31.

Next, in Step S2, the vanishing point estimation part 22 reads out the image from the frame memory 31 and estimates coordinates of a plurality of vanishing points to calculate the tilt angle, the pan angle, and the roll angle of the camera 4 by inputting the read-out image to DNN learned beforehand. The learning method of DNN will be described later.

Next, in Step S3, the camera parameter calculation part 23 calculates the tilt angle, the pan angle, and the roll angle of the camera 4 on the basis of the coordinates of the plurality of vanishing points estimated by the vanishing point estimation part 22.

Next, in Step S4, the output part 24 outputs a camera parameter including the tilt angle, the pan angle, and the roll angle calculated by the camera parameter calculation part 23.

Thus, the coordinates of the plurality of vanishing points to calculate the tilt angle, the pan angle, and the roll angle of the camera 4 are estimated by inputting an image having a distortion to DNN learned by deep learning. From the estimated coordinates of the plurality of vanishing points, the tilt angle, the pan angle and the roll angle of the camera 4, which are camera parameters, can be calculated. Thus, a camera parameter can be calculated from an image having a distortion with high accuracy.

Next, an exemplary camera parameter in the present disclosure will be described below. The conversion formula from the world coordinates system to the image coordinate system is represented by the following equations (1) to (4). The camera parameter is a parameter of a projection formula for projecting a world coordinate to an image coordinate. Γ(η) in the equation (3) is the projection function of the incident angle η, representing a lens distortion. The details of the projection function will be described later. η denotes the incident angle.

$$\begin{matrix}[ Formula 1 ] & \\ [ \begin{matrix}x \\ y \\ 1\end{matrix} ] = [ \begin{matrix}γ / {d}_{x} & 0 & {C}_{x} & 0 \\ 0 & γ / {d}_{y} & {C}_{y} & 0 \\ 0 & 0 & 0 & 1\end{matrix} ] [ \begin{matrix}{X}_{e} \\ {Y}_{e} \\ {Z}_{e} \\ 1\end{matrix} ] & ( 1 )\end{matrix}$$

$$[ \begin{matrix}{X}_{e} \\ {Y}_{e} \\ {Z}_{e} \\ 1\end{matrix} ] = [ \begin{matrix}{r}_{11} & {r}_{12} & {r}_{13} & {T}_{X} \\ {r}_{21} & {r}_{22} & {r}_{23} & {T}_{Y} \\ {r}_{31} & {r}_{32} & {r}_{33} & {T}_{Z} \\ 0 & 0 & 0 & 1\end{matrix} ] [ \begin{matrix}X \\ Y \\ Z \\ 1\end{matrix} ] \qquad ( 2 )$$

$$γ = Γ ( η ) \qquad ( 3 )$$

$$η = arctan ( \frac{\sqrt{{X}_{e}^{2} + {Y}_{e}^{2}}}{{Z}_{e}} ) \qquad ( 4 )$$

Here, (X, Y, Z) denotes world coordinate values, and (x, y) denotes image coordinate values; (Cₓ, C_{y}) represents a principal point of the camera in an image coordinate system; r₁₁ to r₃₃ denote components of a 3×3 rotation matrix R representing rotation with respect to a reference in the world coordinates system; (T_{X}, T_{Y}, T_{Z}) represents a translation vector with respect to the reference in the world coordinates system; and dₓ and d_{y} are pixel pitches of an image sensor of a camera in a lateral direction and a vertical direction, respectively. In the equations (1) to (4), dₓ, d_{y}, Cₓ, C_{y}, r₁₁ to r₃₃, T_{X}, T_{Y}, and T_{Z} are camera parameters. The camera parameter includes an extrinsic parameter for the posture (rotation and translation with respect to a world coordinate reference) of the camera, and an intrinsic parameter for the focal length and the lens distortion.

The equations (1) to (4) represent a conversion from (X, Y, Z) to (x, y). In the case of a conversion from (x, y) to (X, Y, Z) on a unit sphere, an inverse function or an inverse matrix for the equations (1) to (4) are used for the conversion.

An exemplary γ (projection function) for a lens that is symmetrical with respect to the optical axis is represented by the following equations (5) to (9), as a function of the incident angle

$$γ = f sin ( η ) \qquad ( 5 )$$

$$γ = 2 f sin ( η / 2 ) \qquad ( 6 )$$

$$γ = f η \qquad ( 7 )$$

$$γ = 2 f tan ( η / 2 ) \qquad ( 8 )$$

$$γ = f tan ( η ) \qquad ( 9 )$$

The equation (5) represents a projection function for orthogonal projection; the equation (6) represents a projection function for equisolid angle projection; the equation (7) represents a projection function for equidistance projection; the equation (8) represents a projection function for stereographic projection; and the equation (9) represents a projection function for a pinhole camera. f denotes a focal length. η denotes the incident angle.

The general camera model is represented by the following equation (10), which is an N-th degree polynomial.

$$γ = {k}_{1} η + {k}_{2} {η}^{3} + {k}_{2} {η}^{5} + … \qquad ( 10 )$$

In the equation (10) above, η denotes the incident angle, and each of k₁ and k₂ denotes a distortion parameter (distortion coefficient) which is a camera parameter.

For a brief explanation, a case will be described below where the projection function is for the orthogonal projection in the equation (5), and four camera parameters of the tilt angle θ, the pan angle φ, the roll angle ψ, and the focal length f are estimated. The tilt angle θ, the pan angle φ, and the roll angle ψ represent the components r₁₁ to r₃₃ of the rotation matrix in the equation (2) in angles.

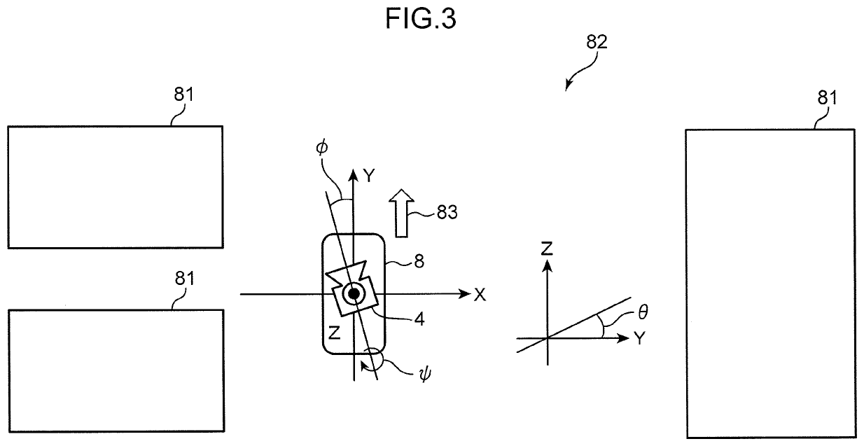

FIG. 3 is a diagram for explaining a world coordinates system in Manhattan World Assumption. FIG. 3 shows a view of a vehicle 8 from above.

The Manhattan World Assumption means a world coordinates system in which a building 81 and a road 82 are arranged into a grid, the X-axis and the Y-axis of the XYZ-O space are parallel to an outer wall of a cuboid building 81, and a positive direction of the Z-axis indicates a direction toward the sky. In the embodiment, the camera 4 is assumed to be placed on the vehicle 8 going forward on the road 82 in the Manhattan World Assumption. The direction in which the vehicle 8 goes forward is a positive direction of the Y-axis, shown by the arrow 83.

As shown in FIG. 3, the tilt angle θ, the pan angle φ, and the roll angle ψ are defined as rotation angles of the camera 4 with respect to the optical axis of the camera 4 in the XYZ-O coordinate system. The focal length f represents the scale of an image. Therefore, the focal length f can be estimated directly from a fisheye image by use of DNN. Thus, a method of calculating the rotation angles of the camera 4 from a fisheye image will be described below. The coordinate system and the rotation angles will be described in the right-handed system.

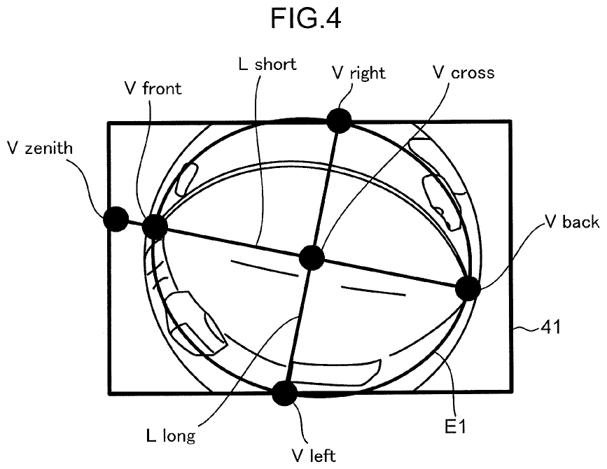

FIG. 4 to FIG. 7 show various exemplary fisheye images and exemplary horizontal lines on the respective fisheye images.

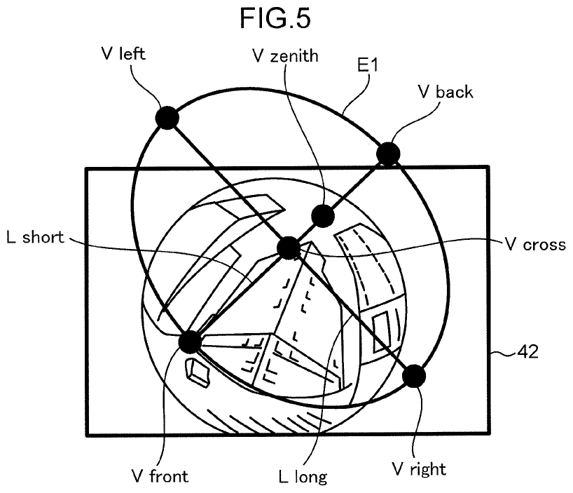

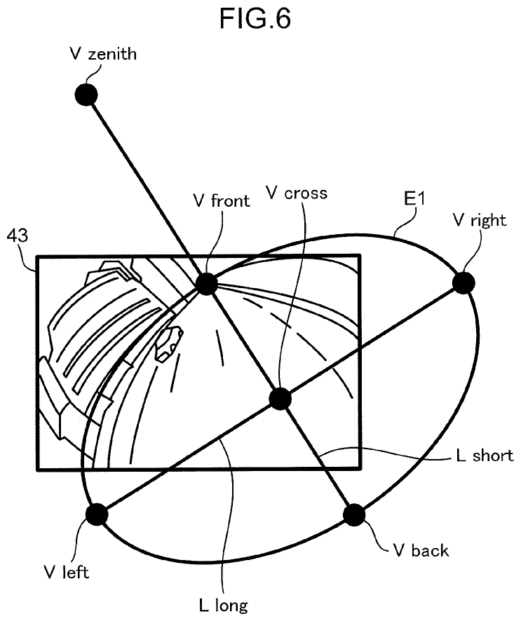

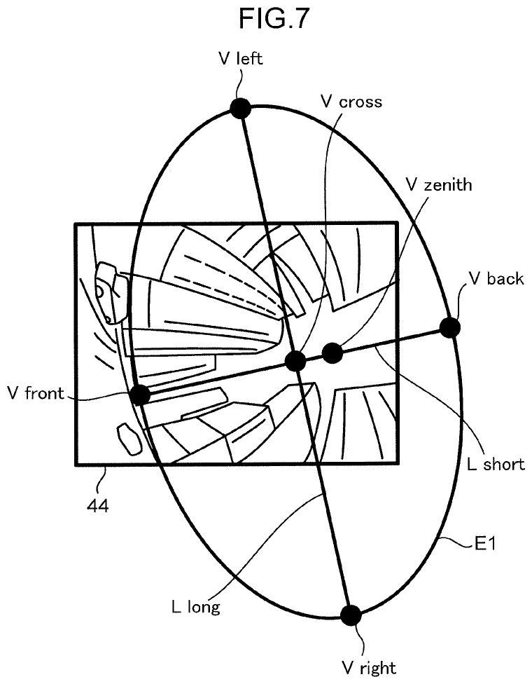

FIG. 4 is an illustration showing an exemplary first fisheye image 41 in the embodiment. FIG. 5 is an illustration showing an exemplary second fisheye image 42 in the embodiment. FIG. 6 is an illustration showing an exemplary third fisheye image 43 in the embodiment. FIG. 7 is an illustration showing an exemplary fourth fisheye image 44 in the embodiment.

The horizontal line in a fisheye image becomes an ellipse or an elliptical arc. Only in the case that the projection system of the fisheye camera is orthogonal projection, the horizontal line becomes an ellipse; and in the case that the projection system of the fisheye camera is other than the orthogonal projection, the horizontal line is in a shape close to an ellipse. Hereinafter, the description will be made on the assumption that the horizontal line is an ellipse even in the case that the projection system is other than the orthogonal projection. The horizontal line in the fisheye image shows the position of a line at infinity of the XY-plane over the image. Each ellipse E1 shown in FIG. 4 to FIG. 7 represents the horizontal line in a fisheye image.

Each point on the ellipse E1 is defined as shown in FIG. 4 to FIG. 7. The first vanishing point V_{front} is a coordinate point in a frontward direction of the camera 4, and corresponds to a point at infinity in the positive direction of the Y-axis. The second vanishing point V_{zenith} is a coordinate point in a zenithal direction of the camera 4, and corresponds to a point at infinity in the positive direction of the Z-axis. The third vanishing point V_{right} is a coordinate point in a rightward direction of the camera 4, and corresponds to a point at infinity in the positive direction of the X-axis. The third vanishing point V_{right} is on the right to the frontward direction of the camera 4, and is an intersection of the horizontal line (ellipse E1) and the X-axis. The fourth vanishing point V_{left} is a coordinate point in a leftward direction of the camera 4, and corresponds to a point at infinity in the negative direction of the X-axis. The fourth vanishing point V_{left} is on the left to the frontward direction of the camera 4, and is an intersection of the horizontal line (ellipse E1) and the X-axis. The fifth vanishing point V_{back} is a coordinate point in a direction opposite to the frontward direction of the camera 4, and corresponds to a point at infinity in the negative direction of the Y-axis. The point V_{cross} is a midpoint of a line segment connecting the third vanishing point V_{right} and the fourth vanishing point V_{left}, and an intersection of the major axis L_{long} and the minor axis Lₛₕₒᵣₜ of the ellipse E1.

The first vanishing point V_{front}, the third vanishing point V_{right}, the fourth vanishing point V_{left}, and the fifth vanishing point V_{back} are on the ellipse E1. The line segment connecting the first vanishing point V_{front} and the fifth vanishing point V_{back} is the minor axis Lₛₕₒᵣₜ of the ellipse E1. The line segment connecting the third vanishing point V_{right} and the fourth vanishing point V_{left} is the major axis L_{long} of the ellipse E1. The second vanishing point V_{zenith} exists on the line passing through the first vanishing point V_{front} and the point V_{cross}.

The tilt angle of the camera is negative when the fisheye images in FIG. 4 and FIG. 6 are acquired, and the tilt angle of the camera is positive when the fisheye images in FIG. 5 and FIG. 7 are acquired.

The vanishing point estimation part 22 estimates coordinates of the first vanishing point V_{front}, the third vanishing point V_{right}, and the fourth vanishing point V_{left}.

The relationship between each point as defined above and the rotation angles of the camera will be described below.

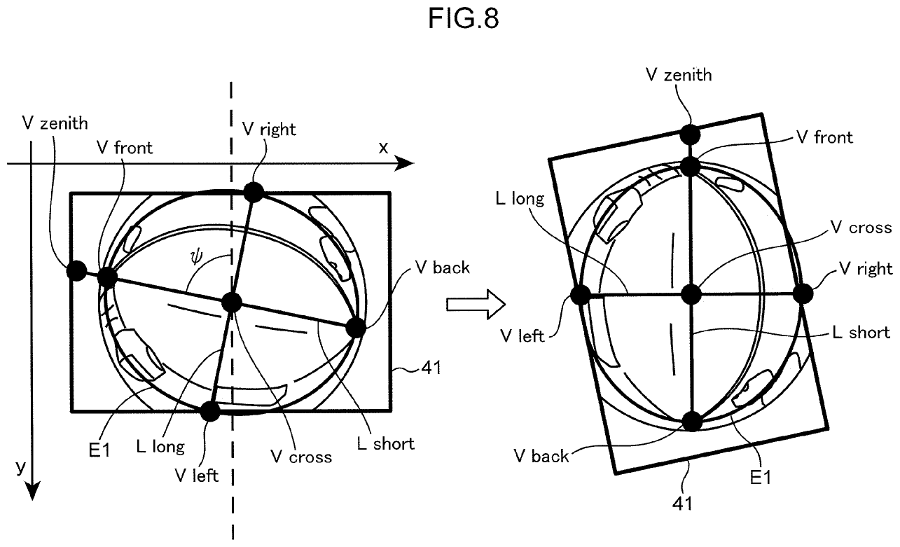

First, a method of calculating the roll angle ψ will be described with reference to FIG. 8.

FIG. 8 is a diagram for explaining a method of calculating the roll angle ψ. When the first fisheye image 41 is rotated according to the roll angle ψ, the minor axis Lₛₕₒᵣₜ of the ellipse E1 becomes parallel to the y-axis of the image coordinate system and the first vanishing point V_{front} is located above the V_{cross} in the image (V_{front}<V_{cross}). The first fisheye image 41 on the left in FIG. 8 represents a state before the rotation, and the first fisheye image 41′ on the right in FIG. 8 represents a state after the rotation. In other words, the roll angle ψ is an angle between the minor axis Lₛₕₒᵣₜ of the ellipse E1 and a vertical direction on the paper surface (y-axis of the image), which is represented by the following equation (11).

$$\begin{matrix}[ Formula 2 ] & \\ ψ = arccos ( 〈 \vec{{V}_{cross} {V}_{front}} , - {e}_{y} 〉 / ‖ \vec{{V}_{c r o s s} {V}_{front}} ‖ ) & ( 11 )\end{matrix}$$

In the equation (11) above, e_{y} denotes a unit vector in the direction of the y-axis in the image coordinate system. The image coordinate system is a coordinate system having the origin at the upper left of the image. <a, b> denotes the inner product of two vectors.

The camera parameter calculation part 23 calculates the roll angle ψ using the coordinate of the first vanishing point V_{front} and the coordinate of the midpoint (point V_{cross}) of the line segment connecting the third vanishing point V_{right} and the fourth vanishing point V_{left}. The camera parameter calculation part 23 calculates the roll angle ψ on the basis of the equation (11) above.

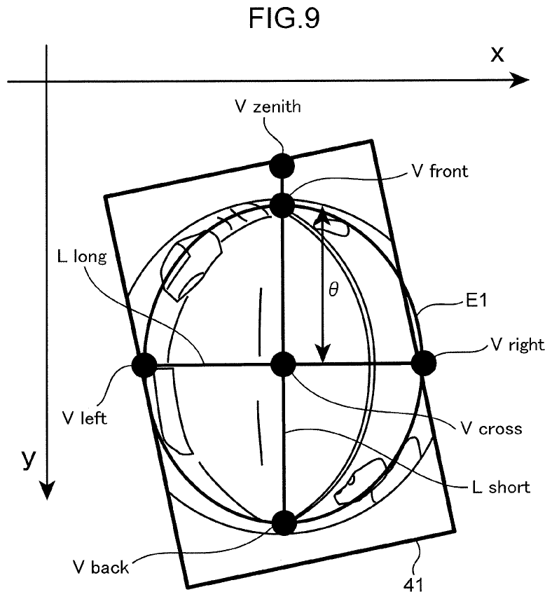

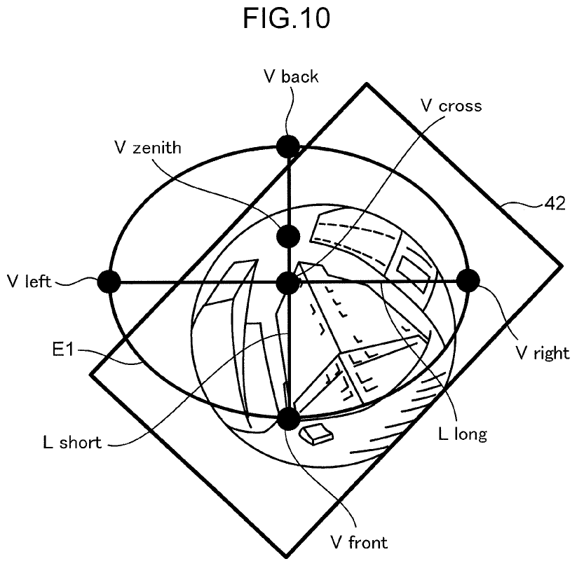

Next, a method of calculating the tilt angle θ will be described with reference to FIG. 9 and FIG. 10.

FIG. 9 is a diagram for explaining a method of calculating a tilt angle θ using the first fisheye image 41 rotated according to the roll angle ψ. FIG. 10 is a diagram for explaining a method of calculating a tilt angle θ using the second fisheye image 42 rotated according to the roll angle ψ.

Since the roll angle ψ has already been calculated on the basis of the equation (11), the description will be made by use of the image after the rotation according to the roll angle ψ as shown in FIG. 9 and FIG. 10.

The relationship of the magnitude between the y-coordinates of the point V_{cross} and the first vanishing point V_{front} in the image coordinate system changes due to the sign of the tilt angle θ. The tilt angle θ is negative in FIG. 9, and the tilt angle θ is positive in FIG. 10. Focusing on FIG. 9, in the case that the tilt angle is −90 degrees (the camera 4 faces right downward), the horizontal line becomes a circle. In contrast, in the case that the tilt angle is zero degrees (the camera 4 faces in a horizontal direction), the horizontal line becomes a line on the image, and the point V_{cross} agrees with the first vanishing point V_{front}.

Here, suppose that the projection function of the camera for the equation (1) to equation (4) is represented by: r=Ω(η), and the inverse function of Ω is Ω⁻¹. η denotes the incident angle, and r denotes the image height (distance from the principal point on the image). When the maximum incident angle for the projection function is 90 degrees, half of the length of the minor axis Lₛₕₒᵣₜ of the ellipse E1 is Lₛₕₒᵣₜ/2, and therefore Lₛₕₒᵣₜ/2=Ω(π/2) holds. The image height at the incident angle of 90 degrees is ½ of the length of the minor axis of the ellipse E1. When this equation is represented with the inverse function, π/2=Ω⁻¹(Lₛₕₒᵣₜ/2) holds. The general incident angle n is given by: η=Ω⁻¹(|V_{front, y}−V_{cross, y}|) (the incident angle is zero degrees or more). The incident angle corresponding to the y-component in the image coordinate system after the rotation according to the roll angle ψ agrees with the absolute value of the tilt angle in the world coordinates system. In FIG. 10, the tilt angle is positive when V_{front, y}−V_{cross, y}>0, thus the tilt angle θ is represented by the following equation (12).

$$θ = sign ( {V}_{front , y} - {V}_{cross , y} ) {Ω}^{- 1} ( \vert {V}_{front , y} - {V}_{cross , y} \vert ) \qquad ( 12 )$$

In the equation (12), sign denotes a sign function, which returns the sign (1 or −1) of an argument. In the case that the argument is zero, it returns zero. V_{front, y} denotes the y-coordinate of the first vanishing point V_{front} in the image coordinate system, and V_{cross, y} denotes the y-coordinate of the point V_{cross} in the image coordinate system. Ω denotes a known projection function of the camera 4. The projection function is stored in the memory 3 beforehand.

The camera parameter calculation part 23 calculates the tilt angle θ using the y-coordinate of the first vanishing point V_{front}, the y-coordinate of the midpoint (point V_{cross}) of the line segment connecting the third vanishing point V_{right} and the fourth vanishing point V_{left}, and the inverse function Ω⁻¹ of the projection function 22 of the camera 4. The camera parameter calculation part 23 calculates the tilt angle θ on the basis of the equation (12) above.

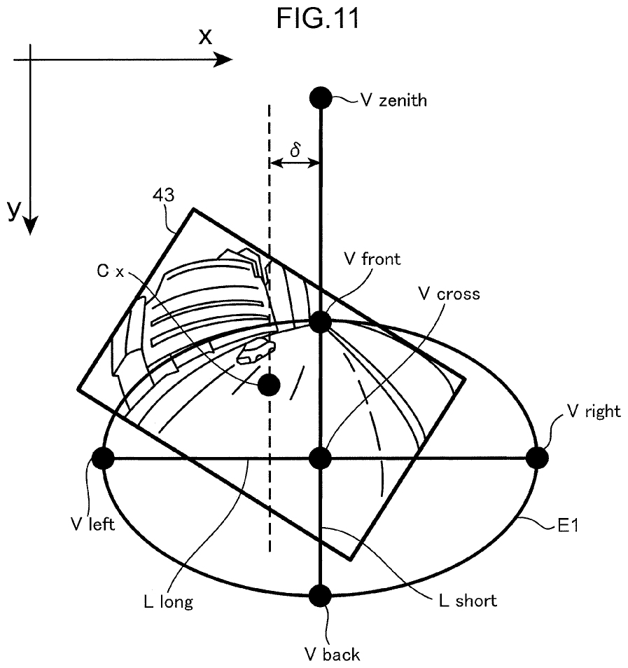

Next, a method of calculating the pan angle φ will be described with reference to FIG. 11.

FIG. 11 is a diagram for explaining the method of calculating the pan angle φ.

The pan angle φ causes a deviation of the point V_{cross} in a horizontal direction (x-axis direction) in the image coordinate system. Focusing on the x-coordinate Cₓ of the principal point on the image and the x-coordinate of the point V_{cross}, the pan angle φ in Manhattan World Assumption is a minimum absolute angle with the X-axis or the Y-axis, which satisfies −π/4≤φ≤π/4.

Specifically, in the case that a pan angle φ that does not satisfy −π/4≤φ≤π/4 is calculated, a pan angle φ is selected by the following procedure. A pan angle φ′ that does not accord with Manhattan World Assumption can be expressed by: 0≤φ′<2π. For a pan angle φ′ that does not accord with Manhattan World Assumption and falls within the range of 0≤φ′≤π/4, the pan angle q′ can be used as the pan angle φ; thus, the pan angle φ′ agrees with the pan angle φ in Manhattan World Assumption. On the other hand, for a pan angle φ′ that does not accord with Manhattan World Assumption and falls within the range of π/4<φ′<2π, the pan angle φ′ is reduced by π/2, π, or 3π/2 in Manhattan World Assumption to thereby select a pan angle φ that satisfies −π/4≤φ≤π/4. For example, in the case that the pan angle φ′ is 11π/12, the pan angle φ becomes −π/12 (=11π/12−π). In this way, the pan angle φ′ is reduced by one of π/2, π, and 3π/2 to ensure a pan angle φ that satisfies −π/4≤φ≤π/4.

Similarly to the description about the tilt angle θ above, the projection function of the camera 4 is represented by: r=Ω(η). Suppose that the deviation in the x-axis direction from the principal point on the image is δ, δ=V_{cross, x}−Cₓ, thus, η=Ω⁻¹(|δ|). V_{cross, x} denotes the x-coordinate of the point V_{cross} in the image coordinate system. From FIG. 11, the pan angle φ is positive when δ>0; thus, the pan angle φ is represented by the following equation (13).

$$φ = sign ( {V}_{cross , x} - {C}_{x} ) {Ω}^{- 1} ( \vert {V}_{cross , x} - {C}_{x} \vert ) \qquad ( 13 )$$

In the equation (13), sign denotes a sign function, which returns the sign (1 or -1) of an argument. In the case that the argument is zero, it returns zero. Cₓ denotes the x-coordinate of the principal point of the camera 4 in the image coordinate system. V_{cross, x} denotes the x-coordinate of the point V_{cross} in the image coordinate system. Ω denotes a known projection function of the camera 4. The projection function is stored in the memory 3 beforehand.

The camera parameter calculation part 23 calculates the pan angle φ using the x-coordinate of the principal point of the camera 4 in the image coordinate system, the x-coordinate of the midpoint (point V_{cross}) of the line segment connecting the third vanishing point V_{right} and the fourth vanishing point V_{left}, and the inverse function Ω⁻¹ of the projection function 22 of the camera 4. The camera parameter calculation part 23 calculates the pan angle φ on the basis of the equation (13) above.

Next, the relationship between the ellipse and each vanishing point on the ellipse will be described. Although each point is defined as shown in FIG. 4 to FIG. 7, the coordinates of the two points of the point V_{cross} and the first vanishing point V_{front} are sufficient to calculate the pan angle φ, the tilt angle θ, and the roll angle ψ. In this regard, if the coordinates of three points among the five points of the first vanishing point V_{front}, the third vanishing point V_{right}, the fourth vanishing point V_{left}, the fifth vanishing point V_{back}, and the point V_{cross} are obtained, the ellipse E1 is uniquely determined. Each point is selected from those on the major axis L_{long} and the minor axis Lₛₕₒᵣₜ.

The V_{cross}, which is not a vanishing point, is difficult to estimate by DNN. Therefore, the case will be described below where coordinates of three or more points among the four points of the first vanishing point V_{front}, the third vanishing point V_{right}, the fourth vanishing point V_{left}, and the fifth vanishing point V_{back} are estimated. Each point is selected from those on the major axis L_{long} and the minor axis Lₛₕₒᵣₜ.

The coordinate of the second vanishing point V_{zenith} is not essential to estimation of the rotation angles, unlike the method of perspective projection for a non-fisheye image, for an ellipse can represent a plane in a three-dimensional space unlike a linear horizontal line. The degree of freedom of an ellipse is larger than the degree of freedom of a line by one, and the coordinate of the second vanishing point V_{zenith} is not essential to the estimation of the rotation angles. Since the three points of the first vanishing point V_{front}, the second vanishing point V_{zenith}, and the fifth vanishing point V_{back} are on the same line, the estimation can be stabilized by using the second vanishing point V_{zenith}. In the case of the third fisheye image 43 shown in FIG. 6, there are vanishing points outside the image, which are difficult to estimate by DNN. Therefore, such stabilization is important. The second vanishing point V_{zenith} corresponds to a position to which a vertical line (curved line in a fisheye image) of a building or the like converges, and thus is easier to estimate by DNN than other vanishing points.

Additionally, the fifth vanishing point V_{back} is a vanishing point at the rear of the camera. Therefore, the fifth vanishing point V_{back} is not in the image, or is on an image circle. The image circle is a boundary between a projected circular region over the image and a not-projected region over the image. In the projection system for the fisheye camera that allows projection by the incident angle of 180 degrees, the rear of the camera is projected onto the image circle. Therefore, the fifth vanishing point V_{back} is difficult to estimate by DNN.

In light of the description above, the case will be described below where the coordinates of the four points of the first vanishing point V_{front}, the second vanishing point V_{zenith}, the third vanishing point V_{right}, and the fourth vanishing point V_{left} are estimated by DNN. A point other than the four points may be estimated.

Hereinafter, a learning device for performing a learning of DNN used in the vanishing point estimation part 22 will be described.

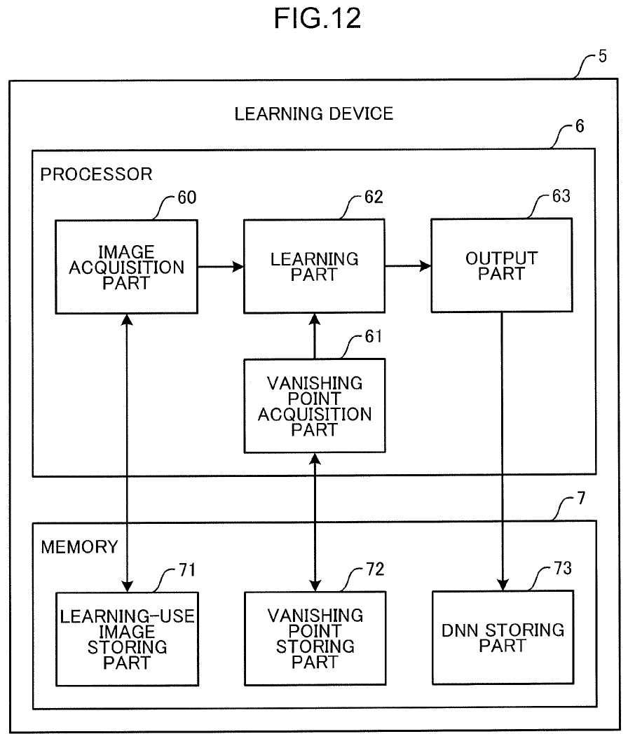

FIG. 12 is a block diagram showing an exemplary structure of a learning device 5 according to the embodiment of the present disclosure.

The learning device 5 is included in a computer having a processor 6, a memory 7, and an unillustrated interface circuit. The processor 6 includes, for example, a central processing unit. The memory 7 includes a storage device that is non-volatile and rewritable, e.g., a flash memory, a hard disk drive, or a solid state drive. The interface circuit includes, for example, a communication circuit.

The learning device 5 may be included in a cloud server, or in a personal computer.

The processor 6 includes an image acquisition part 60, a vanishing point acquisition part 61, a learning part 62, and an output part 63. The image acquisition part 60, the vanishing point acquisition part 61, the learning part 62, and the output part 63 may do performance when the central processing unit executes a learning program, or may be constituted by dedicated hardware, e.g., an ASIC.

The memory 7 includes a learning-use image storing part 71, a vanishing point storing part 72, and a DNN storing part 73.

The learning-use image storing part 71 stores beforehand a plurality of learning-use images taken by a camera that causes a distortion. The learning-use image is used in the learning of DNN. The camera for obtaining the learning-use image is identical to the camera 4. The learning-use image is a fisheye image, which is taken by a fisheye camera in advance. The learning-use image may be generated by executing computer graphics (CG) processing to a panoramic image by use of the camera parameter of the fisheye camera.

The vanishing point storing part 72 stores beforehand coordinates of a plurality of true vanishing points to calculate a tilt angle, a pan angle, and a roll angle of the camera. The plurality of true vanishing points is used in the learning of DNN. The plurality of true vanishing points is a plurality of vanishing points on a learning-use image. The vanishing point storing part 72 stores the plurality of true vanishing points for the learning-use image.

The image acquisition part 60 acquires a learning-use image taken by the camera that causes a distortion. The image acquisition part 60 reads out the learning-use image from the learning-use image storing part 71. In the embodiment, the image acquisition part 60 acquires from the learning-use image storing part 71 the learning-use image stored therein beforehand, but the present disclosure is not particularly limited to this. The image acquisition part 60 may acquire a learning-use image from an external server. In this case, the image acquisition part 60 may receive the learning-use image from the external server. Alternatively, the image acquisition part 60 may acquire a learning-use image from a camera connected to the learning device 5.

The vanishing point acquisition part 61 acquires coordinates of the plurality of true vanishing points to calculate the tilt angle, the pan angle, and the roll angle of the camera. The vanishing point acquisition part 61 reads out the plurality of true vanishing points from the vanishing point storing part 72, and further reads out coordinates associated with the respective vanishing points. In the embodiment, the vanishing point acquisition part 61 acquires the coordinates of the plurality of true vanishing points stored beforehand from the vanishing point storing part 72, but the present disclosure is not particularly limited to this. The vanishing point acquisition part 61 may acquire the coordinates of the plurality of true vanishing points from an external server. In this case, the vanishing point acquisition part 61 may receive the coordinates of the plurality of true vanishing points from the external server. Alternatively, the vanishing point acquisition part 61 may acquire the coordinates of the plurality of true vanishing points input by an operator.

The learning part 62 performs a deep learning of deep neural networks using the learning-use image acquired by the image acquisition part 60 and the coordinates of the plurality of true vanishing points acquired by the vanishing point acquisition part 61.

The learning part 62 estimates coordinates of a plurality of vanishing points to calculate the tilt angle, the pan angle, and the roll angle of the camera by inputting the learning-use image to DNN. The learning part 62 calculates a network error indicative of an error in the tilt angle, the pan angle, and the roll angle on the basis of the coordinates of the plurality of true vanishing points and the estimated coordinates of the plurality of vanishing points.

The plurality of vanishing points includes a first vanishing point along a frontward direction of the camera, a second vanishing point along a zenithal direction of the camera, a third vanishing point along a rightward direction of the camera, and a fourth vanishing point along a leftward direction of the camera over the image.

The learning part 62 calculates a first distance between a perpendicular bisector of a line segment connecting the true third vanishing point and the true fourth vanishing point and a line that is parallel to the perpendicular bisector and passes through the estimated first vanishing point. The learning part 62 calculates a second distance between the perpendicular bisector and a line that is parallel to the perpendicular bisector and passes through the estimated second vanishing point. The learning part 62 calculates a third distance between the true first vanishing point and the estimated first vanishing point in a direction along the perpendicular bisector. The learning part 62 calculates a fourth distance between the true second vanishing point and the estimated second vanishing point in the direction along the perpendicular bisector. The learning part 62 calculates an angle between the line segment connecting the true third vanishing point and the true fourth vanishing point and a line segment connecting the estimated third vanishing point and the estimated fourth vanishing point. The learning part 62 calculates a sum of the calculated first distance, second distance, third distance, fourth distance, and angle as the network error.

The learning part 62 learns a parameter of DNN so as to minimize the calculated network error.

The output part 63 outputs DNN learned by the learning part 62. The output part 63 outputs DNN to the DNN storing part 73.

The DNN storing part 73 stores DNN learned by the learning part 62. In the embodiment, the output part 63 stores DNN learned by the learning part 62 into the DNN storing part 73, but the present disclosure is not particularly limited to this. The output part 63 may output DNN learned by the learning part 62 to an external server. In this case, the output part 63 may transmit DNN to the external server.

Next, the learning process of the learning device 5 will be described with reference to the drawings.

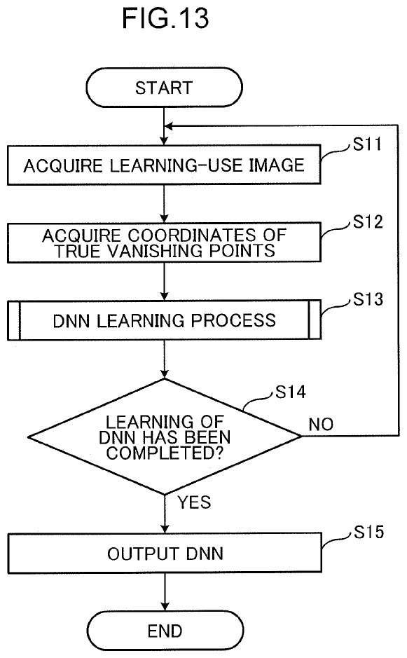

FIG. 13 is a flowchart showing an exemplary learning process of the learning device 5 according to the embodiment of the present disclosure. The operation of the learning device 5 will be described below with reference to FIG. 13.

First, in Step S11, the image acquisition part 60 acquires a learning-use image used for the learning of DNN.

Next, in Step S12, the vanishing point acquisition part 61 acquires coordinates of a plurality of true vanishing points. The plurality of true vanishing points is a true first vanishing point V_{front}, a true second vanishing point V_{zenith}, a true third vanishing point V_{right}, and a true fourth vanishing point V_{left}.

Next, in Step S13, the learning part 62 performs the learning of DNN (DNN learning process) by using the learning-use image and the coordinates of the plurality of true vanishing points.

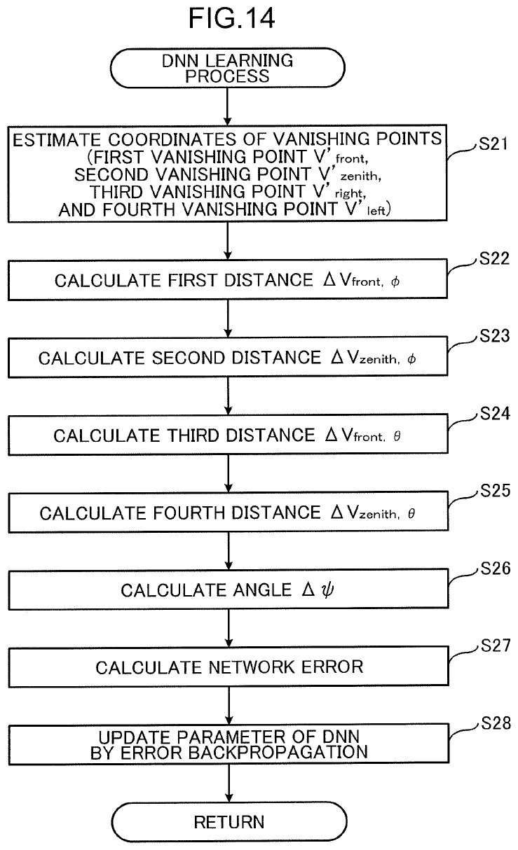

In this regard, the DNN learning process in Step S13 in FIG. 13 will be described. FIG. 14 is a flowchart showing an exemplary DNN learning process in Step 13 in FIG. 13. The operation of the learning part 62 will be described below with reference to FIG. 14.

First, in Step S21, the learning part 62 estimates coordinates of a plurality of vanishing points by inputting a learning-use image to DNN. DNN extracts a feature of the image from a convolutional layer and outputs the eventually estimated coordinates of the plurality of vanishing points. The plurality of vanishing points to be estimated is a first vanishing point V′_{front}, a second vanishing point V′_{zenith}, a third vanishing point V′_{right}, and a fourth vanishing point V′_{left}. The learning part 62 estimates a coordinate of the first vanishing point V′_{front}, a coordinate of the second vanishing point V′_{zenith}, a coordinate of the third vanishing point V′_{right}, and a coordinate of the fourth vanishing point V′_{left}.

Next, in Step S22, the learning part 62 calculates a first distance ΔV_{front, φ} between a perpendicular bisector of a line segment connecting the true third vanishing point V_{right} and the true fourth vanishing point V_{left} and a line L_{front} that is parallel to the perpendicular bisector and passes through the estimated first vanishing point V′_{front}.

Next, in Step S23, the learning part 62 calculates a second distance ΔV_{zenith, φ} between the perpendicular bisector of the line segment connecting the true third vanishing point V_{right} and the true fourth vanishing point V_{left} and a line L_{zenith} that is parallel to the perpendicular bisector and passes through the estimated second vanishing point V′_{zenith}.

Next, in Step S24, the learning part 62 calculates a third distance ΔV_{front, θ} between the true first vanishing point V_{front} and the estimated first vanishing point V′_{front} in a direction along the perpendicular bisector of the line segment connecting the true third vanishing point V_{right} and the true fourth vanishing point V_{left}.

Next, in Step S25, the learning part 62 calculates a fourth distance ΔV_{zenith, θ} between the true second vanishing point V_{zenith} and the estimated second vanishing point V′_{zenith} in the direction along the perpendicular bisector of the line segment connecting the true third vanishing point V_{right} and the true fourth vanishing point V_{left}.

Next, in Step S26, the learning part 62 calculates an angle Δψ between the line segment connecting the true third vanishing point V_{right} and the true fourth vanishing point V_{left} and a line segment connecting the estimated third vanishing point V′_{right} and the estimated fourth vanishing point V′_{left}.

Next, in Step S27, the learning part 62 calculates, as the network error, a sum of the calculated first distance ΔV_{front, φ}, second distance ΔV_{zenith, φ}, third distance ΔV_{front, θ}, fourth distance ΔV_{zenith, θ}, and angle Δψ.

Next, in Step S28, the learning part 62 updates the parameter of DNN by error backpropagation using the calculated network error. The error backpropagation is optimized by use of the stochastic gradient descent or the like.

Reference is back to FIG. 13. Next, in the step S14, the learning part 62 determines whether or not the learning of DNN has been completed. For example, the learning part 62 determines that the learning of DNN has been completed in the case that the number of updatings of the parameter of DNN is greater than a threshold, and determines that the learning of DNN has not been completed in the case that the number of updatings of the parameter of DNN is not greater than the threshold. The threshold is, for example, 10,000 times.

Alternatively, the learning part 62 may determine that the learning of DNN has been completed in the case that the network error is less than a threshold, and determine that the learning of DNN has not been completed in the case that the network error is not less than the threshold.

In the case that the learning of DNN is determined not to have been completed (NO in Step S14), the process returns to Step S11. In Step S11, the image acquisition part 60 acquires another learning-use image.

On the other hand, in the case that the learning of DNN is determined to have been completed (YES in Step S14), the output part 63 outputs DNN learned by the learning part 62 in Step S15. The output part 63 stores DNN into the DNN storing part 73.

Thus, the coordinates of the plurality of vanishing points to calculate the tilt angle, the pan angle, and the roll angle of the camera are estimated by inputting an image having a distortion to DNN learned by deep learning. From the estimated coordinates of the plurality of vanishing points, the tilt angle, the pan angle and the roll angle of the camera, which are camera parameters, can be calculated. Thus, a camera parameter can be calculated from an image having a distortion with high accuracy.

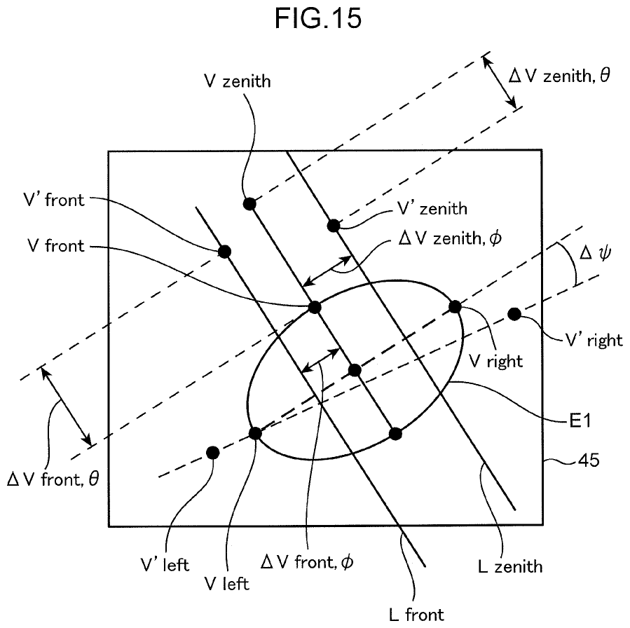

Next, a calculation of the network error by the learning part 62 will be described with reference to FIG. 15.

FIG. 15 is a diagram for explaining a method of calculating the network error in the embodiment.

In FIG. 15, the first vanishing point V_{front}, the second vanishing point V_{zenith}, the third vanishing point V_{right}, and the fourth vanishing point V_{left} are true values in the learning-use image 45. The first vanishing point V′_{front}, the second vanishing point V′_{zenith}, the third vanishing point V′_{right}, and the fourth vanishing point V′_{left} are estimative values estimated by the learning part 62.

First, an error in the pan angle φ will be described.

The true first vanishing point V_{front} and the true second vanishing point V_{zenith} exist on the perpendicular bisector of the line segment connecting the true third vanishing point V_{right} and the true fourth vanishing point V_{left}. However, there is a likelihood that an error in a value estimated by DNN hinders the estimated first vanishing point V′_{front} and the estimated second vanishing point V′_{zenith} from existing on the perpendicular bisector of the line segment connecting the true third vanishing point V_{right} and the true fourth vanishing point V_{left}.

The amount of the error in the pan angle φ is defined as the first distance ΔV_{front, φ} between the perpendicular bisector of the line segment connecting the true third vanishing point V_{right} and the true fourth vanishing point V_{left} and the line L_{front} that is parallel to the perpendicular bisector and passes through the estimated first vanishing point V′_{front}. The amount of the error in the pan angle φ is also defined as the second distance ΔV_{zenith, φ} between the perpendicular bisector of the line segment connecting the true third vanishing point V_{right} and the true fourth vanishing point V_{left} and the line L_{zenith} that is parallel to the perpendicular bisector and passes through the estimated second vanishing point V′_{zenith}. The first distance ΔV_{front, φ} and the second distance ΔV_{zenith, φ correspond to an error in a parameterized pan angle φ.}

Next, an error in the tilt angle θ will be described.

Similarly to the error in the pan angle φ, as shown in FIG. 15, the amount of the error in the tilt angle θ is defined as the third distance ΔV_{front, θ} between the true first vanishing point V_{front} and the estimated first vanishing point V′_{front} in the direction along the perpendicular bisector of the line segment connecting the true third vanishing point V_{right} and the true fourth vanishing point V_{left}. The amount of the error in the tilt angle θ is also defined as the fourth distance ΔV_{zenith, θ} between the true second vanishing point V_{zenith} and the estimated second vanishing point V′_{zenith} in the direction along the perpendicular bisector of the line segment connecting the true third vanishing point V_{right} and the true fourth vanishing point V_{left}. The third distance ΔV_{front, θ} and the fourth distance ΔV_{zenith, θ} correspond to an error in a parameterized tilt angle θ.

Next, an error in the roll angle ψ will be described.

The amount of the error in the roll angle ψ is defined as the angle Δψ between the line segment connecting the true third vanishing point V_{right} and the true fourth vanishing point V_{left} and the line segment connecting the estimated third vanishing point V′_{right} and the estimated fourth vanishing point V′_{left}. The angle Δψ corresponds to an error in a parameterized roll angle ψ.

The network error (loss) indicative of an error in the tilt angle, the pan angle, and the roll angle is represented by the following equation (14).

$$Network Error = {w}_{1} Δ {V}_{front , φ} + {w}_{2} Δ {V}_{zenith , φ} + {w}_{3} Δ {V}_{front , θ} + {w}_{4} Δ {V}_{zenith , θ} + {w}_{5} Δ ψ \qquad ( 14 )$$

In the equation (14) above, w₁ to w₅ are coefficients of the linear combination for the error. For example, w₁, w₂, w₃, and w₄ are 0.5, and w₅ is 1.

The learning part 62 updates a parameter of DNN so as to minimize the calculated network error.

The learning part 62 may calculate, as the network error, a sum of: a squared value of the first distance ΔV_{front, φ}, ΔV²_{front, φ}; a squared value of the second distance ΔV_{zenith, φ}, ΔV²_{zenith, φ}; a squared value of the third distance ΔV_{front, θ}, ΔV²_{front, θ}; a squared value of the fourth distance ΔV_{zenith, θ}, ΔV²_{zenith, θ}; and a squared value of the angle Δψ, Δψ². Alternatively, the learning part 62 may calculate, as the network error, a sum of: the Huber loss of the first distance ΔV_{front, φ}; the Huber loss of the second distance ΔV_{zenith, φ}; the Huber loss of the third distance ΔV_{front, θ}; the Huber loss of the fourth distance ΔV_{zenith, θ}; and the Huber loss of the angle Δψ. The Huber loss is a loss function that gives a squared error for an absolute error of less than 0.5 and gives a linear error for an absolute error of not less than 0.5.

A calculation following the procedure described above enables calculation of the posture of a camera from an elliptical horizontal line, and DNN can be thereby learned by use of the network error based on the world coordinates system. A camera parameter can be thereby calculated with high accuracy from an image distorted by a fisheye camera.

### Modifications

The camera parameter calculation device and the learning device according to one or more aspects of the present disclosure are described above with reference to the embodiment, but the present disclosure is not limited to the embodiment. Various modifications conceivable by one skilled in the art and a combination of constituents in different embodiments are included within the scope of the one or more aspects of the present disclosure as long as those do not deviate from the concept of the present disclosure.

In the embodiments described above, each constituent is constituted by dedicated hardware, or may do performance by executing a software program appropriate for each constituent. Each constituent may do performance by the reading and execution by a program executing part such as a CPU or a processor of a software program stored in a storage medium such as a hard disk or a semiconductor memory.

A part or all of the functions of the device according to the embodiments of the present disclosure are carried out using a Large Scale Integration (LSI) that is typically an integrated circuit. The respective functions may be individually performed by single chips. Alternatively, a part or all of the functions may be performed by a single chip. Additionally, circuit integration is not limited to an LSI and may be realized using a dedicated circuit or a general-purpose processor. A Field Programmable Gate Array (FPGA) that can be programmed after LSI production or a reconfigurable processor that allows connection or reconfiguration of circuit cells inside an LSI after LSI production may be used.

A part or all of the functions of the device according to the embodiments of the present disclosure may be carried out by execution of a program by a processor such as a CPU.

All of the numbers mentioned above are merely examples for describing the present disclosure specifically, which the present disclosure is not limited to.

The order in which each of the steps is executed, shown in the above-mentioned flowchart, is merely an example for describing the present disclosure specifically, and may be varied as long as the similar effects can be exerted. Some of the above-mentioned steps may be executed simultaneously (in parallel) with another step.

The techniques in the present disclosure enable a highly accurate calculation of a camera parameter from an image having a distortion, and thus are useful as a technique of learning deep neural networks for calculating a camera parameter from an image and a technique of calculating a camera parameter from an image.

1. A learning device comprising:
an image acquisition part for acquiring an image taken by a camera that causes a distortion;
a vanishing point acquisition part for acquiring coordinates of a plurality of true vanishing points to calculate a tilt angle, a pan angle, and a roll angle of the camera;
a learning part for performing a deep learning of deep neural networks using the image acquired by the image acquisition part and the coordinates of the plurality of true vanishing points acquired by the vanishing point acquisition part; and
an output part for outputting the deep neural networks learned in the learning part, wherein
the learning part
estimates coordinates of a plurality of vanishing points to calculate the tilt angle, the pan angle, and the roll angle of the camera by inputting the image to the deep neural networks,
calculates a network error indicative of an error in the tilt angle, the pan angle, and the roll angle on the basis of the coordinates of the plurality of true vanishing points and the estimated coordinates of the plurality of vanishing points, and
learns a parameter of the deep neural networks so as to minimize the calculated network error.

2. The learning device according to claim 1, wherein the plurality of vanishing points includes a first vanishing point along a frontward direction of the camera, a second vanishing point along a zenithal direction of the camera, a third vanishing point along a rightward direction of the camera, and a fourth vanishing point along a leftward direction of the camera over the image.

3. The learning device according to claim 2, wherein
the learning part
calculates a first distance between a perpendicular bisector of a line segment connecting the true third vanishing point and the true fourth vanishing point and a line that is parallel to the perpendicular bisector and passes through the estimated first vanishing point,
calculates a second distance between the perpendicular bisector and a line that is parallel to the perpendicular bisector and passes through the estimated second vanishing point,
calculates a third distance between the true first vanishing point and the estimated first vanishing point in a direction along the perpendicular bisector,
calculates a fourth distance between the true second vanishing point and the estimated second vanishing point in the direction along the perpendicular bisector,
calculates an angle between the line segment connecting the true third vanishing point and the true fourth vanishing point and a line segment connecting the estimated third vanishing point and the estimated fourth vanishing point, and
calculates a sum of the first distance, the second distance, the third distance, the fourth distance, and the angle as the network error.

4. A learning method, by a computer, comprising:
acquiring an image taken by a camera that causes a distortion;
acquiring coordinates of a plurality of true vanishing points to calculate a tilt angle, a pan angle, and a roll angle of the camera;
performing a deep learning of deep neural networks using the acquired image and the acquired coordinates of the plurality of true vanishing points; and
outputting the learned deep neural networks, wherein
in the learning of the deep neural networks,
coordinates of a plurality of vanishing points to calculate the tilt angle, the pan angle, and the roll angle of the camera are estimated by inputting the image to the deep neural networks,
a network error indicative of an error in the tilt angle, the pan angle, and the roll angle is calculated on the basis of the coordinates of the plurality of true vanishing points and the estimated coordinates of the plurality of vanishing points, and
a parameter of the deep neural networks is learned so as to minimize the calculated network error.

5. A non-transitory computer readable recording medium storing a learning program causing a computer to serve as:
an image acquisition part for acquiring an image taken by a camera that causes a distortion;
a vanishing point acquisition part for acquiring coordinates of a plurality of true vanishing points to calculate a tilt angle, a pan angle, and a roll angle of the camera;
a learning part for performing a deep learning of deep neural networks using the image acquired by the image acquisition part and the coordinates of the plurality of true vanishing points acquired by the vanishing point acquisition part; and
an output part for outputting the deep neural networks learned in the learning part, wherein
the learning part
estimates coordinates of a plurality of vanishing points to calculate the tilt angle, the pan angle, and the roll angle of the camera by inputting the image to the deep neural networks,
calculates a network error indicative of an error in the tilt angle, the pan angle, and the roll angle on the basis of the coordinates of the plurality of true vanishing points and the estimated coordinates of the plurality of vanishing points, and
learns a parameter of the deep neural networks so as to minimize the calculated network error.

6. A camera parameter calculation device comprising:
an image acquisition part for acquiring an image taken by a camera that causes a distortion;
an estimation part for estimating coordinates of a plurality of vanishing points to calculate a tilt angle, a pan angle, and a roll angle of the camera by inputting the image acquired by the image acquisition part to deep neural networks learned by a deep learning;
a calculation part for calculating the tilt angle, the pan angle, and the roll angle on the basis of the coordinates of the plurality of vanishing points estimated by the estimation part; and
an output part for outputting a camera parameter including the tilt angle, the pan angle, and the roll angle calculated by the calculation part, wherein
in the learning of the deep neural networks,
a learning-use image is acquired,
coordinates of a plurality of true vanishing points to calculate a tilt angle, a pan angle, and a roll angle of a camera used for taking the learning-use image are acquired,
coordinates of a plurality of vanishing points to calculate the tilt angle, the pan angle, and the roll angle of the camera used for taking the learning-use image are estimated by inputting the learning-use image to the deep neural networks,
a network error indicative of an error in the tilt angle, the pan angle, and the roll angle is calculated on the basis of the coordinates of the plurality of true vanishing points and the estimated coordinates of the plurality of vanishing points, and
a parameter of the deep neural networks is learned so as to minimize the calculated network error.

7. The camera parameter calculation device according to claim 6, wherein the plurality of vanishing points includes a first vanishing point along a frontward direction of the camera, a third vanishing point along a rightward direction of the camera, and a fourth vanishing point along a leftward direction of the camera over the image.

8. The camera parameter calculation device according to claim 7, wherein
the calculation part
calculates the roll angle using a coordinate of the first vanishing point and a coordinate of a midpoint of a line segment connecting the third vanishing point and the fourth vanishing point,
calculates the tilt angle using a y-coordinate of the first vanishing point, a y-coordinate of the midpoint of the line segment connecting the third vanishing point and the fourth vanishing point, and an inverse function of a projection function of the camera,
calculates the pan angle using an x-coordinate of a principal point of the camera in an image coordinate system, an x-coordinate of the midpoint of the line segment connecting the third vanishing point and the fourth vanishing point, and the inverse function of the projection function.

9. A camera parameter calculation method, by a computer, comprising:
acquiring an image taken by a camera that causes a distortion;
estimating coordinates of a plurality of vanishing points to calculate a tilt angle, a pan angle, and a roll angle of the camera by inputting the acquired image to deep neural networks learned by a deep learning;
calculating the tilt angle, the pan angle, and the roll angle on the basis of the estimated coordinates of the plurality of vanishing points; and
outputting a camera parameter including the calculated tilt angle, pan angle, and roll angle, wherein
in the learning of the deep neural networks,
a learning-use image is acquired,
coordinates of a plurality of true vanishing points to calculate a tilt angle, a pan angle, and a roll angle of a camera used for taking the learning-use image are acquired,
coordinates of a plurality of vanishing points to calculate the tilt angle, the pan angle, and the roll angle of the camera used for taking the learning-use image are estimated by inputting the learning-use image to the deep neural networks,
a network error indicative of an error in the tilt angle, the pan angle, and the roll angle is calculated on the basis of the coordinates of the plurality of true vanishing points and the estimated coordinates of the plurality of vanishing points, and
a parameter of the deep neural networks is learned so as to minimize the calculated network error.

10. A non-transitory computer readable recording medium storing a camera parameter calculation program causing a computer to serve as:
an image acquisition part for acquiring an image taken by a camera that causes a distortion;
an estimation part for estimating coordinates of a plurality of vanishing points to calculate a tilt angle, a pan angle, and a roll angle of the camera by inputting the image acquired by the image acquisition part to deep neural networks learned by a deep learning;
a calculation part for calculating the tilt angle, the pan angle, and the roll angle on the basis of the coordinates of the plurality of vanishing points estimated by the estimation part; and
an output part for outputting a camera parameter including the tilt angle, the pan angle, and the roll angle calculated by the calculation part, wherein
in the learning of the deep neural networks,
a learning-use image is acquired,
coordinates of a plurality of true vanishing points to calculate a tilt angle, a pan angle, and a roll angle of a camera used for taking the learning-use image are acquired,
coordinates of a plurality of vanishing points to calculate the tilt angle, the pan angle, and the roll angle of the camera used for taking the learning-use image are estimated by inputting the learning-use image to the deep neural networks,
a network error indicative of an error in the tilt angle, the pan angle, and the roll angle is calculated on the basis of the coordinates of the plurality of true vanishing points and the estimated coordinates of the plurality of vanishing points, and
a parameter of the deep neural networks is learned so as to minimize the calculated network error.
